(19) United States
(12) Patent Application Publication
(10) Pub. No.: US 2026/0253601 A1
(43) Pub. Date: Aug. 27, 2026

(54) MULTI-MODEL DEEPFAKE AUDIO DETECTION

(71) Applicant: The Regents of the University of Michigan, Ann Arbor, MI (US)

(72) Inventors: Hashim Ali, Garden City, MI (US); Hafiz M.A. Malik, West Bloomfield, MI (US)

(21) Appl. No.: 19/548,897

(22) Filed: Feb. 24, 2026

Related U.S. Application Data
(60) Provisional application No. 63/762,624, filed on Feb. 24, 2025.

(51) Int. Cl. G10L 25/51

(52) U.S. Cl. CPC G10L 25/51

(57) ABSTRACT

A method and system for detecting a deepfake audio resource. The method includes: obtaining training data having positive-classification training data and negative-classification training data; training a single-class machine learning (ML) model using the positive-classification training data; training a multi-class machine learning (ML) model using the positive-classification training data and the negative-classification training data; and generating a deepfake audio indicator for a subject audio resource based on a single-class output and a multi-class output. The single-class output is generated through inputting the subject audio resource into the single-class ML model, and the multi-class output is generated through inputting the subject audio resource into the multi-class ML model.

### GOVERNMENT FUNDING

This invention was made with government support under 1816019 and 2309443 awarded by the National Science Foundation. The government has certain rights in the invention.

### TECHNICAL FIELD

This disclosure relates to detecting a deepfake, spoofed, or otherwise illegitimate audio sample, clip, file, or other resource having human speech.

### BACKGROUND

In recent years, advancements in artificial intelligence and machine learning have facilitated the creation of highly realistic synthetic media, including deepfake audio. These audio manipulations can convincingly mimic the voice of a specific individual, posing significant challenges in fields such as security, privacy, and media integrity. Existing approaches to detect deepfake audio primarily rely on single-model frameworks, which often struggle to adapt to the diverse and evolving nature of deepfake techniques. Traditional detection methods typically focus on identifying specific artifacts or inconsistencies within the audio signal, but these methods are increasingly inadequate as deepfake technology becomes more sophisticated.

A significant technical challenge in the current state of the art is the ability to accurately and reliably detect deepfake audio across various conditions, including different speakers, recording environments, and manipulation techniques. Many existing solutions are limited by their reliance on a single classification model, which may not effectively generalize across different types of deepfake generation methods or adapt to new and unforeseen spoofing strategies. Furthermore, the dynamic nature of audio environments, such as variations in noise levels and recording devices, exacerbates the difficulty of maintaining robust detection capabilities.

### SUMMARY

According to a first aspect of the invention, there is provided a method of detecting a deepfake audio resource. The method includes: obtaining training data having positive-classification training data and negative-classification training data; training a single-class machine learning (ML) model using the positive-classification training data; training a multi-class machine learning (ML) model using the positive-classification training data and the negative-classification training data; and generating a deepfake audio indicator for a subject audio resource based on a single-class output and a multi-class output, wherein the single-class output is generated through inputting the subject audio resource into the single-class ML model, and wherein the multi-class output is generated through inputting the subject audio resource into the multi-class ML model.

According to various embodiments, the method of the first aspect of the invention may further include any one of the following features or any technically-feasible combination of some or all of these features:
the single-class ML model is or includes a support vector machine (SVM) trained on the positive-classification training data;
the multi-class ML model is or includes a Gaussian mixture model (GMM) trained on the positive-classification training data and the negative-classification training data;
the single-class ML model is or includes a support vector machine (SVM) trained on the positive-classification training data;
the multi-class ML model is or includes a Gaussian mixture model (GMM) trained on the positive-classification training data and the negative-classification training data;
the training data is generated using a training data generation process;
the training data generation process includes a spoof audio generation process for generating deepfake audio resources used as the negative-classification training data;
either or both of the single-class ML model and the multi-class ML model is/are trained for a public figure or other particular individual;
the single-class ML model is trained for an individual and the multi-class ML model is trained for the individual;
a trained single-class ML model is generated as a result of training the single-class ML model;
a trained multi-class ML model is generated as a result of training the multi-class ML model;
a unitary ML model is trained using reinforcement learning (RL) in which RL training data is automatically generated through inputting a plurality of subject audio resources into the trained single-class ML model and the trained multi-class ML model to generate a plurality of deepfake audio indicators for the plurality of subject audio resources; and/or
the RL training data includes a plurality of RL training data entries each having one of the subject audio resources and a corresponding one of the plurality of deepfake audio indicators.

According to a second aspect of the invention, there is provided a method of detecting a deepfake audio resource. The method includes: obtaining a plurality of trained expert machine learning (ML) models, wherein the plurality of trained expert ML models includes two or more experts configured for a common or different detection tasks; obtaining a trained gating model configured to generate per-expert weights and/or routing decisions based on one or more inputs associated with a subject audio resource; inputting the subject audio resource into each of the plurality of trained expert ML models to generate a plurality of expert outputs, wherein each expert output of the plurality of expert outputs is an output of a different one of the plurality of trained expert ML models; inputting at least one of: (i) a feature representation derived from the subject audio resource and/or (ii) one or more of the plurality of expert outputs into the trained gating model to generate gating outputs indicating relative weighting or selection of the plurality of trained expert ML models; and generating a deepfake audio indicator for the subject audio resource by fusing the plurality of expert outputs in accordance with the gating outputs.

According to various embodiments, the method of the second aspect of the invention may further include any one or more of those features discussed above in connection with the first aspect of the invention and/or any of the following features or any technically-feasible combination of some or all of these features:
the gating outputs control contribution of each of the plurality of trained expert ML models to the deepfake audio indicator;
the plurality of trained expert ML models includes any one or more of the following: one or more speaker-specific experts, one or more channel or capture-condition experts, one or more attack-type experts, and one or more laundering experts;
the trained gating model is configured to generate soft routing weights comprising continuous-valued per-expert weights;
fusing the plurality of expert outputs comprises computing a weighted aggregation of the plurality of expert outputs using the soft routing weights;
the trained gating model is configured to perform hard routing by selecting a subset of the plurality of trained expert ML models based on a routing criterion;
fusing the plurality of expert outputs comprises combining outputs only from the selected subset;
the trained gating model receives as input one or more of: (i) an embedding derived from the subject audio resource, (ii) side information associated with the subject audio resource, and/or (iii) one or more uncertainty measures derived from the plurality of expert outputs;
the side information associated with the subject audio resource includes one or more environmental or transmission characteristics derived from the subject audio resource;
fusing the plurality of expert outputs comprises score-level fusion and/or temporal fusion;
score-level fusion includes at least one of weighted averaging, logistic regression stacking, Bayesian model averaging, temperature scaling, or isotonic calibration;
temporal fusion is performed by aggregating expert outputs over multiple time segments of the subject audio resource prior to generating the deepfake audio indicator;
providing the fused output to an output resolver configured to generate the deepfake audio indicator based on one or more decision thresholds;
the output resolver is further configured to generate one or more auxiliary outputs including at least one of: (i) a predicted attack type, (ii) a confidence score, (iii) an uncertainty estimate, (iv) an identified channel or capture condition, and/or (v) an identified speaker grouping;
the output resolver applies a risk-aware decision policy comprising at least one of: (i) selecting a minimum or maximum spoof score among the plurality of expert outputs, (ii) applying a conservative threshold conditioned on an uncertainty measure, and (iii) generating a flag for further review when disagreement among the plurality of expert outputs exceeds a predefined threshold;
fusing the plurality of expert outputs comprises computing a weighted sum of the plurality of expert outputs using per-expert weights generated by the trained gating model;
fusing the plurality of expert outputs comprises stacking, including inputting the plurality of expert outputs into a meta-classifier configured to generate the deepfake audio indicator;
the trained gating model comprises a neural network configured to implement a mixture-of-experts framework that generates continuous-valued weights applied to the plurality of expert outputs;
the trained gating model receives, as part of the one or more inputs associated with the subject audio resource, an estimated codec type associated with the subject audio resource;
the trained gating model receives, as part of the one or more inputs associated with the subject audio resource, an estimated signal-to-noise ratio (SNR) associated with the subject audio resource;
the trained gating model receives one or more conditioning signals including at least one of: a codec estimate, a signal-to-noise ratio estimate, a reverberation estimate, a capture-type estimate, metadata associated with a source platform, and/or a speaker identity estimate;
adapting the system to a new deployment domain by updating parameters of the trained gating model while maintaining parameters of the plurality of trained expert ML models fixed; and/or
adapting the system further comprises updating parameters of a fusion layer or calibration layer without retraining the plurality of trained expert ML models.

According to a third aspect of the invention, there is provided a system for detecting deepfake audio. The system includes: one or more processors; and a non-transitory, computer-readable memory storing computer instructions. Execution of the computer instructions by the one or more processors causes the system to: obtain a plurality of trained expert machine learning (ML) models, the plurality of trained expert ML models including two or more experts configured for a common detection task or for different detection tasks; obtain a trained gating model configured to generate per-expert weights or routing decisions based on one or more inputs associated with a subject audio resource; input the subject audio resource into each of the plurality of trained expert ML models to generate a corresponding plurality of expert outputs; input at least one of (i) a feature representation derived from the subject audio resource and/or (ii) one or more of the plurality of expert outputs into the trained gating model to generate gating outputs indicating relative weighting or selection of the plurality of trained expert ML models; and generate a deepfake audio indicator for the subject audio resource by fusing the plurality of expert outputs in accordance with the gating outputs, wherein the gating outputs control contribution of each of the plurality of trained expert ML models to the deepfake audio indicator.

According to various embodiments, the system of the third aspect of the invention may further include any one or more of those features discussed above in connection with the first aspect of the invention, the second aspect of the invention, and/or any of the following features or any technically-feasible combination of some or all of these features:
the execution of the computer instructions causes the system to provide the fused output to an output resolver configured to generate the deepfake audio indicator based on one or more decision thresholds; and/or
the execution of the computer instructions further causes the system to adapt to a new microphone, platform, language, or channel condition by retraining the trained gating model while keeping the plurality of trained expert ML models frozen.

According to a fourth aspect of the invention, there is provided a method of detecting a deepfake audio resource. The method includes: obtaining a subject audio resource; computing one or more feature representations or embeddings from the subject audio resource; executing a plurality of machine learning (ML) models using at least one of the one or more feature representations or embeddings to generate a corresponding plurality of model outputs; computing a combination of the plurality of model outputs by determining one or more weights, selection decisions, or aggregation parameters; and generating, based on the combination of the plurality of model outputs, an indicator representing whether the subject audio resource is manipulated.

According to various embodiments, the method of the fourth aspect of the invention may further include any one or more of those features discussed above in connection with the first aspect of the invention, the second aspect of the invention, the third aspect of the invention, and/or any of the following features or any technically-feasible combination of some or all of these features:
the execution of the computer instructions causes the system to provide the fused output to an output resolver configured to generate the deepfake audio indicator based on one or more decision thresholds; and/or
the execution of the computer instructions further causes the system to adapt to a new microphone, platform, language, or channel condition by retraining the trained gating model while keeping the plurality of trained expert ML models frozen.

According to a fifth aspect of the invention, there is provided a method of detecting a deepfake audio resource. The method includes: obtaining a subject audio resource; computing one or more feature representations or embeddings from the subject audio resource; executing a plurality of machine learning (ML) models using at least one of the one or more feature representations or embeddings to generate a corresponding plurality of model outputs; computing a combination of the plurality of model outputs by determining one or more weights, selection decisions, or aggregation parameters; and generating, based on the combination of the plurality of model outputs, an indicator representing whether the subject audio resource is manipulated.

According to various embodiments, the method of the fifth aspect of the invention may further include any one or more of those features discussed above in connection with the first aspect of the invention, the second aspect of the invention, the third aspect of the invention, the fourth aspect of the invention, and/or any of the following features or any technically-feasible combination of some or all of these features:
computing the combination of the plurality of model outputs comprises at least one of: weighted averaging, logistic regression stacking, Bayesian model averaging, or learned gating; and/or
computing the combination of the plurality of model outputs comprises updating only aggregation parameters associated with the combination while maintaining parameters of the plurality of machine learning models unchanged.

According to various embodiments, the method of the first aspect of the invention may further include any one or more of those features discussed above in connection with the second aspect of the invention, the third aspect of the invention, the fourth aspect of the invention, and the fifth aspect of the invention.

According to various embodiments, the method of the second aspect of the invention may further include any one or more of those features discussed above in connection with the third aspect of the invention, the fourth aspect of the invention, and the fifth aspect of the invention.

According to various embodiments, the method of the third aspect of the invention may further include any one or more of those features discussed above in connection with the fourth aspect of the invention and the fifth aspect of the invention.

According to various embodiments, the method of the fourth aspect of the invention may further include any one or more of those features discussed above in connection with the fifth aspect of the invention.

According to a sixth aspect of the invention, there is provided a non-transitory, computer-readable medium that stores computer instructions. When the computer instructions are executed by one or more processors, the method of the first aspect of the invention is performed. The sixth aspect of the invention may further include any one or more of the features discussed above in connection with the first aspect of the invention.

According to a seventh aspect of the invention, there is provided a non-transitory, computer-readable medium that stores computer instructions. When the computer instructions are executed by one or more processors, the method of the second aspect of the invention is performed. The seventh aspect of the invention may further include any one or more of the features discussed above in connection with the second aspect of the invention.

According to an eighth aspect of the invention, there is provided a non-transitory, computer-readable medium that stores computer instructions. When the computer instructions are executed by one or more processors, the method of the fourth aspect of the invention is performed. The eighth aspect of the invention may further include any one or more of the features discussed above in connection with the fourth aspect of the invention.

According to a ninth aspect of the invention, there is provided a non-transitory, computer-readable medium that stores computer instructions. When the computer instructions are executed by one or more processors, the method of the fifth aspect of the invention is performed. The ninth aspect of the invention may further include any one or more of the features discussed above in connection with the fifth aspect of the invention.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram depicting a deepfake audio detection environment having a deepfake audio detection system, according to one embodiment;

FIG. 2 is a block diagram depicting a deepfake detection framework that is configured to implement a deepfake detection ML network pipeline, according to one embodiment;

FIG. 3 is a block diagram depicting a portion of the deepfake detection framework of FIG. 2, including a deepfake detection ML network training pipeline, according to one embodiment;

FIG. 4 is a block diagram depicting a portion of the deepfake detection framework of FIG. 2, including a deepfake detection trained ML network pipeline, according to one embodiment; and

FIG. 5 is a flowchart depicting a method of detecting a deepfake audio resource, according to one embodiment.

### DETAILED DESCRIPTION

The system and method described herein enable detecting a deepfake or other spoofed or illegitimate audio resource as being illegitimate, particularly through use of a machine learning (ML) network employing two person-or speaker-specific trained ML models for such deepfake detection. In the context of the present application, the system and method are directed toward detecting a deepfake, spoofed, or otherwise illegitimate audio sample, clip, file, or other resource having human speech, which is referred to herein as a “deepfake audio resource”; also, the term “deepfake audio indicator” refers to an indicator indicating whether a subject audio resource is a deepfake audio resource or not. Accordingly, in embodiments, the system and method are configured to detect (and provide positive deepfake audio indicators for) deepfake audio resources generated using deepfake technology as well as those that do not use deepfake technology but nonetheless still include audio purporting to be speech of a particular individual. Indeed, according to at least some embodiments, the manner in which the deepfake audio resource is generated is irrelevant to the deepfake detection performed by the system and method, as described herein.

According to embodiments, the ML network employs two or more person-specific trained ML models for deepfake detection; thus, in such embodiments, the number of persons for which the ML models are trained is two or more. Furthermore, according to embodiments, the number of ML models trained and included as a part of the ML network is set according to the number of expert sets to be used as a part of the ML network architecture. Different expert groups/sets may be used, such as, for example, speaker-specific experts, channel/capture experts, attack-type experts, and/or laundering experts. Also, in embodiments, different types of ML network ensembles may be used, such as, for example, those having a first-stage gate that selects an expert subset (corresponding to a subset of the experts) and a second-stage fusion that combines within the expert subset.

More particularly, at least according to some embodiments, the ML network employs a single-class ML model that uses non-spoofed or real (“legitimate”) audio resources for training (referred to as “positive-classification training data” in such a training context) as well as a multi-class ML model that uses deepfake audio resources for training (referred to as “negative-classification training data” in such a training context) in addition to the positive-classification training data. In embodiments, outputs of the single-class ML model and the multi-class ML model are then combined or otherwise both used for determining the deepfake detection indicator.

Aspects of the present disclosure are directed to improving detection of deepfakes that had been generated as a result of a laundering attack, such as where additive noise, reverberation, and/or recompression is/are introduced—such audio deepfakes are referred to herein as “laundered audio deepfakes” or simply “laundered deepfakes”. Embodiments of the present technology accomplish such a feat through employing two ML models: a first or single-class ML model, which may be or include a support vector machine (SVM), for example; and a second or multi-class ML model, which may be a or include a Gaussian Mixture Model (GMM), for example. Of course, in other embodiments, other ML models may be used, as will be appreciated by those skilled in the art in light of the teachings herein.

As a part of appropriately configuring the ML network, the first and second ML models thereof are trained using training data. As noted above, in at least some embodiments, the single-class ML model is trained using only deepfake or illegitimate audio resources, whereas the multi-class ML model is trained using both the deepfake audio resources as well as legitimate audio resources. The single-class ML model and the multi-class ML model are then employed together as a part of a trained ML network that is configured to detect deepfake or illegitimate audio, including laundered deepfakes.

At least in embodiments, the ML network is trained for detecting deepfake or other illegitimate audio resources that purport to be recordings of a particular individual, such as a public figure. As used herein, “speaker-specific” operates to adjectivally characterize its subject as being specific to a particular individual human; for example, a speaker-specific audio resource refers to an audio resource having audio with discernable speech from a particular speaker. And, as another example, a speaker-specific ML model refers to an ML model trained or otherwise adapted for a particular speaker. Also, as used herein, “sole-speaker-specific” operates to adjectivally characterize its subject as being specific to a particular individual human (“speaker”) and to only that speaker, meaning to no other speaker; for example, a sole-speaker-specific audio resource refers to an audio resource having audio (speech or utterances) from only a single, particular speaker and includes no audio of any other speaker. As another example, a sole-speaker-specific ML model refers to an ML model trained or otherwise adapted for handling inputs and/or generating outputs that are specific to a particular speaker and only that speaker; however, this does not mean that such a sole-speaker-specific ML model is necessarily trained using only sole-speaker-specific audio resources, but rather the ML model is configured for handling inputs and/or generating outputs solely for the sole individual.

A training process is performed using training data that is generated using a training data generation process in which training data having audio resources of the individual (“speaker”) is generated. The training data generation process is performed in order to generate a suitable number of training data entries, each of which includes an audio resource. In embodiments, illegitimate audio resources are generated through an audio deepfake generation process, which includes using a speaker-specific audio deepfake ML model to generate speaker-specific deepfake audio resources, including sole-speaker-specific deepfake audio resources. The training data is then used for training the ML network, particularly through training the single-class ML model and the multi-class ML model.

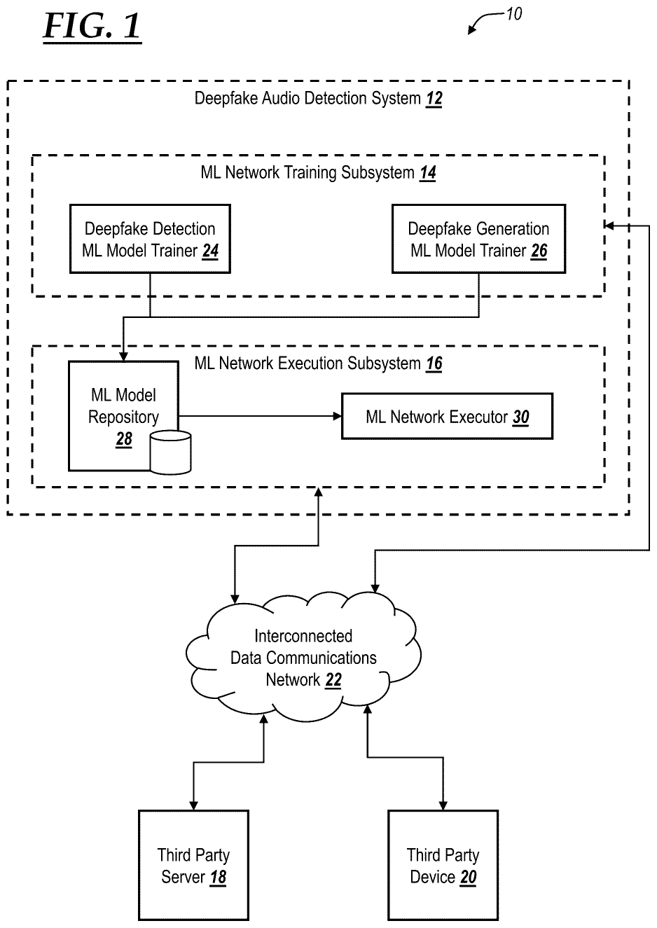

With reference now to FIG. 1, there is shown a deepfake audio detection environment 10 depicting data-communicative relationships amongst the various components of the system 10, which include a deepfake audio detection system 12 having a ML network training subsystem 14 and a ML network execution subsystem 16, a third party server 18, and a third party device 20, which are each communicatively coupled to an interconnected data communications network 22, such as the internet or other non-local interconnected network used for electronic data communications.

The deepfake audio detection system 12 is a computer-implemented system that, according to embodiments, may use any number, arrangement, type, or configuration of computers, other computing devices, etc., as will be appreciated by those skilled in the art. The system 12 is used to perform various functionality, as discussed herein, such as the method(s) and process(es) discussed herein; such functionality is performed by the system 12 through using at least one electronic processor to execute computer instructions, which are stored in memory.

According to embodiments, each of the computer processors or electronic processors discussed herein is an electronic processor that may be implemented as any suitable electronic hardware that is capable of processing computer instructions and may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc. According to embodiments, each of the memory or memory devices described herein is or includes non-transitory, computer-readable memory and may be implemented as any suitable type of memory that is capable of storing data or information in a non-volatile manner and in an electronic form so that the stored data or information is consumable by a processor. The memory may be any of a variety of different electronic memory types and may be selected based on the application in which it is to be used. Examples of types of memory that may be used include magnetic or optical disc drives, ROM (read-only memory), solid-state drives (SSDs) (including other solid-state storage such as solid state hybrid drives (SSHDs)), other types of flash memory, hard disk drives (HDDs), non-volatile random access memory (NVRAM), etc. It will be appreciated that any one or more of the computers or computer systems discussed herein may include other memory, such as volatile RAM that is used by the processor, and/or multiple processors.

The deepfake audio detection system 12 is a system that is used for detecting illegitimate or audio resources (also referred to as “deepfake audio resources,” “deepfake audio,” or “deepfake resources”) and providing an indicator indicating the same. And, more particularly, in at least some embodiments, the deepfake audio detection system 12 is configured for detecting deepfake audio of a set of particular individuals (referred to as the “subject individual(s)” or “subject speaker(s)”), such as one or more politicians, notorious or otherwise famous persons, or other particular persons. In such embodiments, the deepfake audio detection system 12 uses the ML network training subsystem 14 for obtaining a trained deepfake detection ML model for each of the subject individual(s) and then uses each respective sole-speaker-specific trained deepfake detection ML model for processing audio from the respective subject individual in order to detect audio deepfakes of that individual. Also, in such embodiments, the ML network training subsystem 14 may be used for generating or obtaining a sole-speaker-specific deepfake generation ML model for each of the subject individual(s) and then using each respective sole-speaker-specific deepfake generation ML model for generating deepfake audio to be used as a part of negative-classification training data when training a ML model to generate a deepfake detection ML model for the respective individual to be used for individualized or sole-speaker-specific deepfake audio detection of new or unseen speaker-specific audio resources.

The ML network training subsystem 14 is used for training ML models using deepfake detection training data in order to generate a deepfake detection ML network having the trained ML models. As discussed above, in at least one embodiment, the deepfake detection ML network includes a first or single-class deepfake detection ML model and a multi-class deepfake detection ML model that are both used together as a part of the deepfake detection ML network. In at least some embodiments, the single-class ML model and the multi-class ML models are both trained for the same, specific individual and are each considered a sole-speaker-specific deepfake detection ML model. The deepfake detection training data is training data used for training ML models for deepfake detection, and includes a plurality of training data entries, each of which includes audio resources.

Although the ML network training subsystem 14 is used for training ML models for deepfake detection, the ML network training subsystem 14 may also be used for training ML models for deepfake generation, which is useful for generating deepfake detection training data used for training ML models, such as the single-class ML model and the multi-class ML model, for deepfake detection. In one embodiment, a deepfake generation ML model is generated for a particular individual as a sole-speaker-specific deepfake generation ML model. In other embodiments, one or more sole-speaker-specific deepfake generation ML models are obtained from a third party ML model provider, which may be provided by the third party server 18, for example.

The ML network training subsystem 14 is implemented by a ML model training computer system that includes at least one computer used for performing training and any other functionality discussed herein as being attributed to or performed by the ML network training subsystem 14. In one embodiment, the training of ML models for deepfake generation is performed on different computer(s) (of the at least one computer) than the computer(s) (of the at least one computer) used for training ML models for deepfake detection; however, in some embodiments, the training of ML models for both deepfake generation and deepfake detection is performed on the same computer(s). Also, in one embodiment, training of deepfake detection models may be performed using the same or different computers, such as where the single-class deepfake detection ML model is trained on a different set of computers (of the at least one computer) than the set of computers (of the at least one computer) used for training the multi-class ML model.

The ML network training subsystem 14 includes a deepfake detection ML model trainer 24 and, in the depicted embodiment, further includes a deepfake generation ML model trainer 26. However, in other embodiments, the deepfake generation ML model trainer 26 is omitted and trained deepfake generation ML models and/or deepfake generation output data (deepfakes generated by trained deepfake generation ML model(s)) are obtained and used for obtaining training data for the deepfake detection ML model training process performed by the deepfake detection ML model trainer 24. The deepfake detection ML model trainer 24 is used for training one or more ML models that are used as a part of a ML network for deepfake detection. In embodiments, the deepfake detection ML network that is to be trained and configured includes two trained ML models, including a single-class ML model and a multi-class ML model. Although a single deepfake detection ML model trainer is shown and described in the present embodiment, it will be appreciated that separate ML trainers may be used for different ML models that are used or to be used as a part of the deepfake detection ML network. For example, in one embodiment, the deepfake detection ML model trainer 24 includes a first trainer configured for training the single-class ML model and a second trainer configured for training the multi-class ML model. These trainers, which correspond to software modules implemented by at least one processor executing computer instructions, may share resources, be performed by the same or different computers, or may otherwise be configured in a number of different ways, depending on the application and environment in which they are used and implemented.

The ML network execution subsystem 16 is used for deepfake detection and referred to as a deepfake detection subsystem, and performs deepfake detection through executing one or more trained deepfake detection ML models using an audio resource as input thereinto. Such audio resources that are considered for deepfake detection are each referred to here as a “subject audio resource.” For each subject audio resource, the deepfake detection ML network generates a deepfake detection indicator that indicates whether the subject audio resource is a deepfake or not; that is, it indicates whether the subject audio resource is illegitimate or not. Furthermore, at least in some embodiments, two separate deepfake detection ML models are each used to receive the subject audio resource and generate a deepfake detection result, and the two deepfake detection results are then combined or otherwise used together to form, generate, or otherwise obtain the deepfake detection indicator for the subject audio resource.

The ML network execution subsystem 16 includes an ML model repository 28 and an ML network executor 30. The ML model repository 28 stores the trained deepfake detection ML models and permits access by the ML model executor 30 to the deepfake detection ML models stored in the repository 28. The ML model repository 28 is implemented using one or more non-transitory, computer-readable memory devices, and may be implemented using memory devices local to or a part of the hardware components used for the ML network execution subsystem 16 and/or may be stored remotely, such as on a virtual private network accessible via the interconnected data communications network 22. The ML model executor 30 is used for executing one or more trained deepfake detection ML models, and this may include performing inference using the trained deepfake detection ML model(s) on an input or subject audio resource. As shown in FIG. 1, ML models trained by the deepfake detection ML model trainer 24 are provided to the ML model repository 28 and stored therein and then used by the ML network execution subsystem 16 for execution in order for deepfake detection. Also, as shown in FIG. 1, in at least some embodiments, deepfake generation ML models, such as those trained by the deepfake generation ML model trainer 26, are stored in the ML model repository 28. In embodiments, the ML model repository 28 includes multiple different tables, directories, schemas, or partitions for storing different types of models, and may be implemented using any of a number of different model repository or storage platforms.

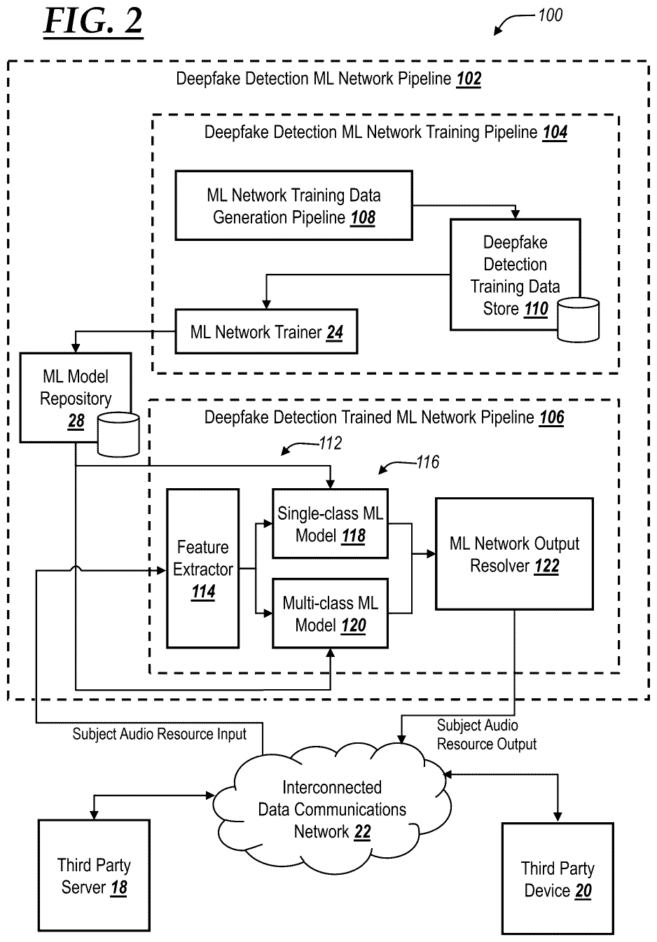

With reference to FIGS. 2-4, there is shown a deepfake detection framework 100 implementing a deepfake detection ML network pipeline 102 for deepfake detection for a particular individual whereby a deepfake detection ML network generates a deepfake detection indicator for the particular individual based on a subject audio resource for the particular individual. The deepfake detection ML network pipeline 102 (or “deepfake detection pipeline” for short) includes a deepfake detection ML network training pipeline 104 for generating a trained ML network and a deepfake detection trained ML network pipeline 106 for executing the trained ML network in order to determine whether a subject audio resource is a deepfake or otherwise illegitimate or not, and may include classifying a type of deepfake, such as through use of a multi-class deepfake detection ML model. The deepfake detection framework 100 and its pipeline 102 are implemented using the deepfake detection system 12.

In general, the deepfake detection ML network training pipeline 104 is used for training a ML network for deepfake detection in order to obtain a trained ML network. The trained ML network is then stored in the ML model repository 28, thereby permitting the deepfake detection trained ML network pipeline 106 access to the trained ML network. The deepfake detection trained ML network pipeline 106 is used for determining a deepfake detection indicator, which is an indicator indicating that the subject audio resource is a deepfake or otherwise illegitimate or not. The deepfake detection indicator also may indicate a type of spoofing or deepfake for the subject audio resource, such as, for example, through use of a multi-class deepfake detection ML model.

The deepfake detection ML network training pipeline 104 includes a ML network training data generation pipeline 108 for generating deepfake training data, a deepfake training data store 110 for storing the deepfake training data, and the ML network trainer 24 for training a ML model in order to generate a deepfake detection trained ML network, which is then output by the deepfake detection ML network training pipeline 104 and stored in the ML model repository 28.

The deepfake detection trained ML network pipeline 106 is used for executing the deepfake detection ML network that was trained by the deepfake detection ML network training pipeline 104 for an inputted subject audio resource, which is shown as being received as a subject audio resource input from the interconnected data communications network 22. The subject audio resource input may be sent or provided by a user using the third party device 20 or automatically by the third party server 18, for example. In some embodiments, the user indicates a uniform resource locator (URL) at which the subject audio resource may be accessed.

The deepfake detection trained ML network pipeline 106 includes a deepfake detection trained ML network 112 and, in FIG. 2, this trained ML network 112 includes an audio feature extractor 114 used for extracting features and a deepfake detection classifier network 116 comprised of a single-class ML model 118 and a multi-class ML model 120. The single-class ML model generates a binary indicator indicating, with a first value (e.g., 0, False), that the subject audio resource is a deepfake or otherwise illegitimate and indicating, with a second value (e.g., 1, True), that the subject audio resource is not a deepfake or is otherwise legitimate. In the case of executing multiple ML models as a part of the deepfake detection classifier network 116, the respective outputs of the ML models (e.g., a single-class output for the single-class ML model 118 and a multi-class output for the multi-class ML model 120) are then combined or otherwise each used for determining a subject audio resource output, which indicates whether the subject audio resource is not a deepfake or is otherwise legitimate and, in embodiments, may indicate further information regarding the subject audio resource, such as a type or source of the subject audio resource, for example, when the subject resource is determined to be a deepfake. The subject audio resource output is shown as being provided to the interconnected data network 22, which may be used for ultimately providing the subject audio resource output to the third party server 18 and/or the third party device 20, such as for storage in a third party database or viewing by a user on an electronic display screen of the third party device 20, for example.

According to one embodiment, the single-class ML model 118 is a one-class support vector machine (SVM) that is trained on the positive class in the training data or positive training data, which includes legitimate or bonafide audio samples or resources and not deepfake audio resources. In other embodiments, the single-class ML model 118 may be trained on deepfake audio resources (or negative training data) as well.

According to one embodiment, the multi-class ML model 120 is a Gaussian mixture model (GMM) that is trained on both positive and negative training data. The GMM is useful when the collected audio resources for the subject speaker contain many different types of audio deepfakes. Alas, due to the infeasibility or impracticality of acquiring such types of deepfakes, the one-class or single-class ML model 118 provides useful robustness and/or corroboration for determinations made by the multi-class ML model 120. Accordingly, together, the single-class ML model 118 and the multi-class ML model 120 are used together as part of the deepfake detection classifier network 116 to classify unseen audio samples or resources as either being bonafide or illegitimate.

In embodiments, a plurality of single-class ML models (each corresponding to the single-class ML model 118) is used. Furthermore, in embodiments, a plurality of multi-class ML models (each corresponding to the multi-class ML model 120) is used. Also, in embodiments, the number of single-class ML models may be the same as the number of multi-class ML models; however, in other embodiments, the number of single-class ML models is different than the number of multi-class ML models, such as where the number of single-class ML models is greater than the number of multi-class ML models or where the number of single-class ML models is less than the number of multi-class ML models. Also, in embodiments, the particular number and type of single-class and/or multi-class ML models is selected based on the needs or desires of the particular use case or application in which the deepfake detection classifier network 116 is to be used.

According to embodiments, each of the plurality of single-class ML models is configured for performing a different task (relative to other ones of the plurality of single-class ML models). Likewise, in embodiments, each of the multi-class ML models is configured for performing a different task (relative to other ones of the plurality of multi-class ML models). These tasks of the ML models are each referred to herein as an expert task. Also, in embodiments, the number of expert tasks is N and, in embodiments, the number of single-class ML models is equal to N and/or the number of multi-class ML models is equal to N. Also, in embodiments, for each expert task n (where n denotes an instance of N), a pair of ML models is configured where each pair of ML models includes a single-class ML model and a multi-class ML model that are both configured according to the same expert task.

According to embodiments, the set of expert tasks (having N expert tasks) to be performed by the deepfake detection classifier network 116 includes a task for any one or more of the following: one or more speaker-specific experts (where N_{S} is the number of speaker-specific experts), one or more channel/capture experts (where N_{C} is the number of channel/capture experts), one or more attack-type experts (where N_{A} is the number of attack-type experts), and one or more laundering experts (where N_{L} is the number of laundering experts).

The speaker-specific experts refer to an expert task for a particular speaker and, in embodiments, a different speaker-specific expert is used for each of the speakers for which the deepfake detection classifier network 116 is to be used; for example, a first speaker-specific expert is trained and configured for a first speaker and a second speaker-specific expert is trained and configured for a second speaker. This may be useful as different speakers have unique acoustic traits, for example.

The channel/capture experts refer to an expert task for a particular recording channel or capture condition and, in embodiments, a different channel/capture expert is used for each of the channels or capture conditions for which the deepfake detection classifier network 116 is to be used; for example, a first channel/capture expert is trained and configured for a first capture condition (e.g., studio microphone recording) and a second channel/capture expert is trained and configured for a second capture condition (e.g., telephone or far-field microphone recording). This may be useful as different recording channels and capture setups introduce distinct acoustic characteristics, artifacts, frequency responses, noise profiles, and compression effects, for example.

The attack-type experts refer to an expert task for a particular spoofing or manipulation attack type and, in embodiments, a different attack-type expert is used for each of the attack types for which the deepfake detection classifier network 116 is to be used; for example, a first attack-type expert is trained and configured for text-to-speech (TTS) attacks, a second attack-type expert is trained and configured for voice conversion (VC) attacks, and a third attack-type expert is trained and configured for replay attacks. This may be useful as different attack types introduce distinct artifacts and signal inconsistencies, such as vocoder artifacts in TTS, spectral-temporal mismatches in VC, or environmental and device-induced distortions in replay attacks, for example.

The laundering experts refer to an expert task for a particular post-processing or obfuscation condition applied to manipulated audio and, in embodiments, a different laundering expert is used for each of the laundering conditions for which the deepfake detection classifier network 116 is to be used; for example, a first laundering expert is trained and configured for re-encoding or compression-based laundering, a second laundering expert is trained and configured for noise-addition or reverberation-based laundering, and a third laundering expert is trained and configured for filtering or equalization-based laundering. This may be useful as laundering operations are intended to mask or attenuate artifacts introduced by spoofing attacks, and different laundering techniques introduce distinct secondary distortions, spectral smoothing effects, bandwidth limitations, or environmental signatures, for example.

As discussed above, in certain embodiments, instead of combining only two models, the deepfake audio detection system 12 comprises N expert models, where N≥2. At least according to embodiments, each expert is an independently parameterized and trained model configured to specialize in a particular aspect of the overall classification or detection task. The experts operate in parallel on a shared or partially shared input and produce intermediate outputs (e.g., logits, posterior probabilities, embeddings, or confidence scores). These outputs are subsequently combined using an ensemble mechanism to produce a final system-level decision. An expert ML model refers to a distinct machine learning model (e.g., neural network, probabilistic model, or other classifier) trained for a defined specialization, such as a particular data distribution, objective function, feature representation, or robustness condition.

According to embodiments, different types of ensemble networks may be used as a part of the deepfake audio detection system 12. An ensemble (or ensemble network) refers to a composite model structure that aggregates predictions from multiple experts. Ensemble networks may be used in order to improve predictive performance, robustness, or generalization relative to any individual expert.

According to embodiments, different types of fusion layers may be used as a part of the deepfake audio detection system 12. A fusion layer refers to the computational component that merges expert outputs (outputs from the ML models). Fusion may be implemented via fixed rules (e.g., averaging), learned weighting mechanisms, stacking with a meta-classifier, attention-based weighting, or gating mechanisms that selectively activate a subset of experts. In embodiments, a fusion ML model is used for performing the fusion of two or more ML models, such as those outputs of ML models configured for a common task (such as those from a pair of single-class/multi-class ML models) or those outputs from ML models used for different types of tasks.

In certain embodiments, fusion may be performed at different representational levels, including, for example, score-level, decision-level, embedding-level, and/or temporal fusion. In score-level fusion, numerical outputs such as logits or posterior probabilities from the experts are combined using techniques such as weighted averaging, logistic regression stacking, isotonic regression calibration, Platt scaling, or Bayesian model averaging. In decision-level fusion, discrete expert decisions are combined using rules such as majority voting, logical AND/OR safety rules (e.g., flagging an input if any expert exceeds a high-confidence threshold), or veto logic in which one or more designated experts may override others based on predefined thresholds. In embedding-level fusion, intermediate feature representations or embeddings produced by multiple feature extractors are concatenated or otherwise combined, optionally projected through a learned fusion layer, and then provided to a downstream classifier, thereby maintaining modularity with respect to individual feature extraction techniques. In further embodiments involving streaming or temporally extended audio, temporal fusion may be applied to combine model outputs over time, such as through Hidden Markov Model (HMM) or Conditional Random Field (CRF) smoothing, exponential moving averages, or other sequential aggregation techniques, which may thereby improve stability and consistency of detection decisions across consecutive audio segments.

In certain embodiments, the fusion mechanism is implemented using a learned gating or routing framework consistent with a mixture-of-experts formulation. A gating network is provided that outputs per-expert weights, selection probabilities, or routing decisions indicating which experts should contribute to the final decision for a given input. Experts may be specialized according to any suitable partitioning scheme, including by synthesis mechanism (e.g., text-to-speech, voice conversion, replay/recapture), by generative model family or codec/vocoder family, by attack or laundering style, by speaker group or language/accent, by channel or capture pipeline, and/or by joint regimes that combine generation type with channel conditions. The gating network may receive as input one or more embeddings or feature representations derived from the subject audio, optional side information such as estimated codec, signal-to-noise ratio (SNR), reverberation characteristics, capture type (direct versus recaptured), speaker identity (if available), or platform/source metadata, as well as uncertainty or confidence measures produced by one or more experts.

In operation, the gating network may implement soft routing, such as a weighted mixture of expert outputs; top-k selection in which only a subset of experts contribute; or hard routing in which a single expert is selected for inference. Hierarchical routing may also be employed, wherein a coarse expert family is first selected and a finer-grained expert is subsequently chosen within that family, or cascaded screening may be used in which a computationally inexpensive expert performs an initial assessment before invoking a more computationally intensive expert. In embodiments, the gating mechanism may incorporate uncertainty estimation and an abstention or reject option, such that the system may defer a decision, request additional evidence (e.g., a longer audio segment), or trigger enhanced analysis when overall confidence is below a predefined threshold, thereby enabling safer operation in high-stakes deployment scenarios.

In certain embodiments, the deepfake audio detection system 12 further incorporates shift-aware fusion, calibration, and low-cost adaptation mechanisms to improve robustness under distribution shift and evolving deployment conditions. For example, one or more components may estimate distribution shift conditions, such as channel mismatch, codec mismatch, unseen synthesis methods, or other environmental changes, and apply calibration to expert scores and/or gating outputs prior to final fusion. Calibration mechanisms may include temperature scaling, isotonic regression, score normalization, or related techniques that adjust score distributions to maintain well-calibrated confidence estimates. In some embodiments, adaptation to new environments (e.g., new microphones, platforms, languages, or codecs) is achieved by updating only the gating network, fusion layer, or calibration layer, while keeping the underlying experts frozen. According to embodiments, this approach reduces computational cost, limits retraining requirements, and preserves previously validated expert behaviors.

In further embodiments, the deepfake audio detection system 12 may implement risk-aware fusion policies designed for high-stakes detection scenarios. For example, aggregation rules may be risk-averse (e.g., selecting the maximum spoof score across experts), apply conservative thresholds conditioned on uncertainty estimates, or utilize two-stage decision processes in which inputs exhibiting high expert disagreement are flagged for manual review. Expert disagreement or output variance may itself be treated as a signal of novelty, distribution shift, or potential adversarial activity, thereby triggering fallback policies such as requesting additional audio evidence, requesting re-capture of the input, routing to a generalist expert, or abstaining from a definitive decision. In one embodiment, experts may be trained under different augmentation curricula or data partitions (e.g., distinct synthesis families, laundering styles, or channel conditions), thereby promoting diversity in learned representations; however, such training strategies represent one specialization approach among many and are not required.

In embodiments, the N experts may be organized and diversified into N_{S} different speaker-specific experts, N_{C} different channel/capture experts, N_{A} different attack-type experts, and/or N_{L} different laundering experts. Each expert within these categories (or expert groups) is implemented as an independent model block having its own learned parameters and, in some embodiments, its own feature front-end and training objective. The total number of experts N may therefore be expressed as a function of these groupings (e.g., N≥N_{S}+N_{C}+N_{A}+N_{L}), with possible overlap or additional expert types in certain embodiments). In embodiments, each expert processes an input representation and produces an output vector, such as logits, posterior probabilities, embeddings, or confidence scores, which are subsequently provided to a fusion layer for aggregation into a final system-level decision.

The use of structured expert groupings enables specialization along multiple independent dimensions of variability. As discussed above, speaker-specific experts (N_{S}) may model speaker-dependent characteristics; channel/capture experts (N_{C}) may model recording-condition-dependent distortions; attack-type experts (N_{A}) may model artifacts associated with specific spoofing mechanisms; and laundering experts (N_{L}) may model post-processing transformations intended to obscure attack traces. Because each group captures different statistical structure in the input data, the resulting experts exhibit complementary decision boundaries and partially uncorrelated error patterns. At least according to embodiments, when their outputs are combined through an ensemble or hierarchical fusion mechanism, the deepfake audio detection system 12 achieves improved robustness, adaptability, and generalization across heterogeneous speakers, recording environments, attack modalities, and post-processing conditions.

In certain embodiments, different experts are trained using different objective functions or problem formulations, even when operating on substantially similar or identical input data. For example, one or more experts may be trained using a one-class objective in which only genuine (non-spoofed) samples are used during training, and the model learns a representation of normality for the genuine class. In such embodiments, detection is performed by measuring deviation from the learned distribution, such as through a one-class SVM objective, density estimation criterion, or reconstruction-based loss (e.g., an autoencoder trained to minimize reconstruction error on genuine samples). In contrast, one or more other experts may be trained using a binary classification objective to discriminate between genuine and spoofed inputs, typically optimized using a binary cross-entropy loss. Still further, one or more experts may be trained using a multi-class objective to distinguish among multiple categories (e.g., genuine, text-to-speech, voice conversion, replay), typically optimized using a softmax cross-entropy loss.

At least in embodiments, during inference, each expert produces an output score, logit vector, or posterior probability corresponding to its respective objective formulation. These outputs are normalized as appropriate to the objective type, such as by applying a sigmoid activation for binary outputs or a softmax activation for multi-class outputs, prior to being provided to a fusion layer for aggregation. In embodiments, the use of heterogeneous training objectives enables the ensemble to capture complementary statistical structure in the data. For example, one-class experts emphasize modeling the intrinsic distribution of genuine inputs and detecting anomalies, whereas binary and multi-class experts focus on learning discriminative decision boundaries between classes. When combined within an ensemble framework, these differing perspectives enhance robustness and improve overall detection performance.

In certain embodiments, the experts differ in their feature front-end, where a feature front-end refers to the preprocessing and representation-learning pipeline that transforms raw input data into a feature representation suitable for classification or detection. For example, one expert may operate on handcrafted acoustic features such as Mel-Frequency Cepstral Coefficients (MFCCs), while another may utilize time-frequency representations such as spectrograms or Mel-spectrograms. In other embodiments, an expert may process raw waveform inputs directly using learned convolutional layers, thereby jointly learning feature extraction and classification in an end-to-end manner. Still further, one or more experts may operate on learned embeddings derived from pretrained self-supervised models, such as wav2vec-style representations, which encode higher-level acoustic and phonetic information.

In such embodiments, the processing pipeline for expert n may be represented as: Input→Feature Extractorₙ→Expertₙ→Scoreₙ. Each expert may include its own feature extractor with independent parameters, or alternatively, feature extraction layers may be partially shared across experts and fine-tuned per expert specialization. Different feature representations emphasize different signal characteristics, such as spectral structure, temporal dynamics, phase-related information, or long-range contextual dependencies. At least according to embodiments, by incorporating multiple feature front-ends across the ensemble, the deepfake audio detection system 12 captures complementary aspects of the input signal, thereby improving robustness and overall classification performance.

In certain embodiments, one or more experts are trained to specialize in robustness against specific perturbations or distribution shifts that may occur during real-world deployment. Such perturbations may include additive noise, audio compression artifacts, reverberation, bandwidth limitation, and adversarial perturbations, among others. Each robustness-specialized expert is trained using targeted data augmentation strategies that simulate its designated perturbation class. For example, a compression-robust expert may be trained on audio signals encoded using multiple codecs and bitrates to learn invariance to quantization and encoding artifacts, while a noise-robust expert may be trained with additive noise injected at varying signal-to-noise ratios. Similarly, a reverberation-robust expert may be trained using room impulse response simulations, and an adversarially robust expert may be trained using adversarial training procedures.

According to embodiments, by exposing each expert to a specific class of perturbations during training, the deepfake audio detection system 12 encourages the learning of invariant or stable feature representations under those conditions. This specialization improves resilience under distribution shift because, when the deployed system encounters degraded or altered inputs, at least one expert is likely to maintain strong performance, at least in embodiments. Through the fusion mechanism, the ensemble can aggregate or adaptively weight expert outputs such that greater influence is given to experts whose robustness specialization aligns with the characteristics of the input, thereby improving overall reliability and stability of the system under adverse conditions.

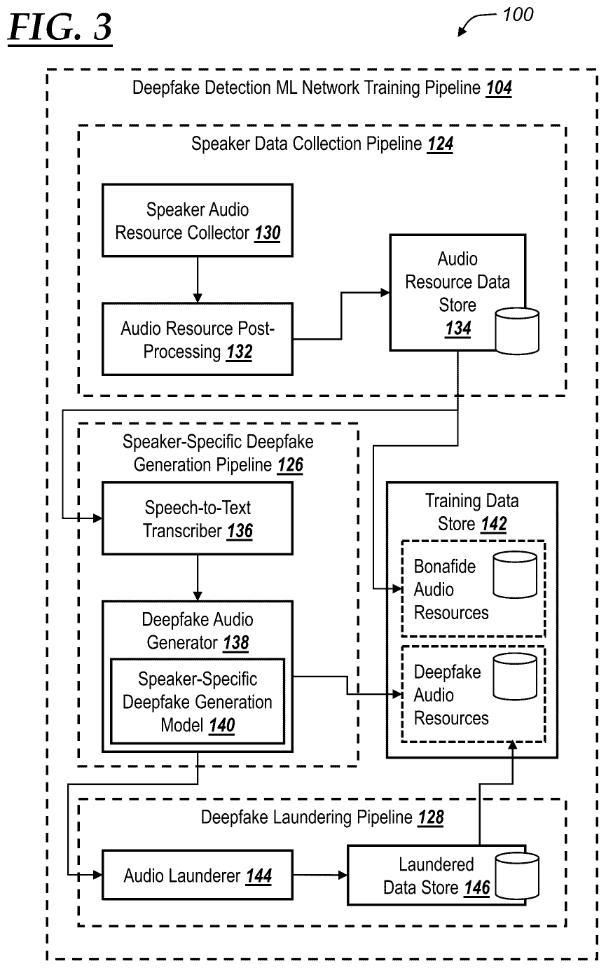

With specific reference now to FIG. 3, there is shown the ML network training data generation pipeline 104, which includes a speaker data collection pipeline 124 for obtaining legitimate (“bonafide”) audio resources for a subject speaker, a speaker-specific deepfake generation pipeline 126 for generating deepfake audio versions of the bonafide audio resources, and a deepfake laundering pipeline 128 for modifying the deepfake audio versions using one or more deepfake laundering techniques in order to generate laundered deepfake audio data. Accordingly, at least in one embodiment, the ML network training data generation pipeline 104 generates training data entries including single-class ML model training data for training a single-class ML model and multi-class ML model training data for training a multi-class ML model. The singe-class ML model training data may include a plurality of single-class or binary training data entries, each of which includes a subject audio resource as input and a binary deepfake indicator indicating whether or not the subject audio resource is a deepfake or a bonafide resource. The multi-class ML model training data may include a plurality of multi-class training data entries, each of which includes a subject audio resource as input and an audio classification indicator, such as a deepfake classification indicator indicating a type of deepfake, for the subject audio resource.

The speaker data collection pipeline 124 is used for collecting real audio recordings of the subject speaker, such as a public figure (e.g., President of the United States of America), and storing the recordings as bonafide audio resources, which may then be used for training. The speaker data collection pipeline 124 includes a speaker audio resource collector 130 for obtaining real audio recordings of the subject speaker, a post-processor 132 for performing standardization or other various desired processing prior to storage in order to generate prepared audio resource data, and an audio resource data store 134 for storing the prepared audio resource data. In embodiments, the speaker audio resource collector 130 obtains the bonafide audio resources automatically, such as, for example, through automatically searching YouTube™ for URLs of the speaker in which the speaker speaks, downloading the resulting videos using the URLs, and then extracting audio from the videos to obtain extracted audio. For example, the videos may be downloaded using Python™ script utilizing the Python™ library named “yt_dl” and, after downloading a video file, the audio is extracted from the downloaded video file into a WAV format with a sampling rate of 16 KHz, for example. The extracted audio may be diarized using speaker diarization technique(s) to determine which a speaker for each portion of speech within the extracted audio. Those portions in which the speaker is the subject speaker are then used as legitimate or bonafide audio resources for the subject speaker. Prior to being stored in the audio resource data store 134, the audio resources may be processed by the post-processor 132 in order to prepare the audio resource data for storage and/or for one or more intended uses, such as for training.

The speaker-specific deepfake generation pipeline 126 is used for generating deepfake audio versions of the bonafide audio resources stored in the audio resource data store 134. The speaker-specific deepfake generation pipeline 126 includes a speech-to-text transcriber 136 for transcribing the bonafide audio resources into a textual version represented as audio transcription data, a deepfake audio generator 138 that uses the audio transcription data as input into a speaker-specific deepfake generation model 140 for the subject speaker in order to generate deepfake audio versions of the transcribed text, and a training data store 142 for storing the generated deepfake audio versions and each's corresponding bonafide audio resource for the subject speaker.

The speaker-specific deepfake generation model 140 is a ML model for generating deepfake audio for a transcription input, such as text representing speech. In one embodiment, the speaker-specific deepfake generation model 140 is generated training or otherwise adapting an audio deepfake generation base model, such as those provided by ElevenLabs™ or StyleTTS/StyleTTS2™, to the subject speaker through using the transcription inputs and corresponding audio resources. In other embodiments, the speaker-specific deepfake generation model 140 is trained or otherwise developed by a third party and obtained therefrom, such as from the third party server 18 or the third party device 20 via the interconnected data communications network 22. For example, ParrotAI™ does not presently allow training f new models, but has already trained deepfake audio generation models for many famous figures.

The deepfake laundering pipeline 128 is used for modifying deepfake audio in order to generate laundered versions of the deepfake audio that include audio laundering attack artifacts, which is any artifact indicative or suggestive of a laundering attack for an audio resource. The audio laundering attack artifacts are introduced by an audio launderer 144, and the resulting laundered deepfake audio may be stored in a data store (referred to as the laundered data store) 146 and/or in the training data store 142 for use as negative training data.

The bonafide and deepfake audio resources may be divided into train and test partitions with a partition train: test ratio of, for example, 70:30. This partitioned data is then passed to the feature extractor 114 where, for example, three types of features are extracted, namely prosody, articulation, and phonation, as discussed more below.

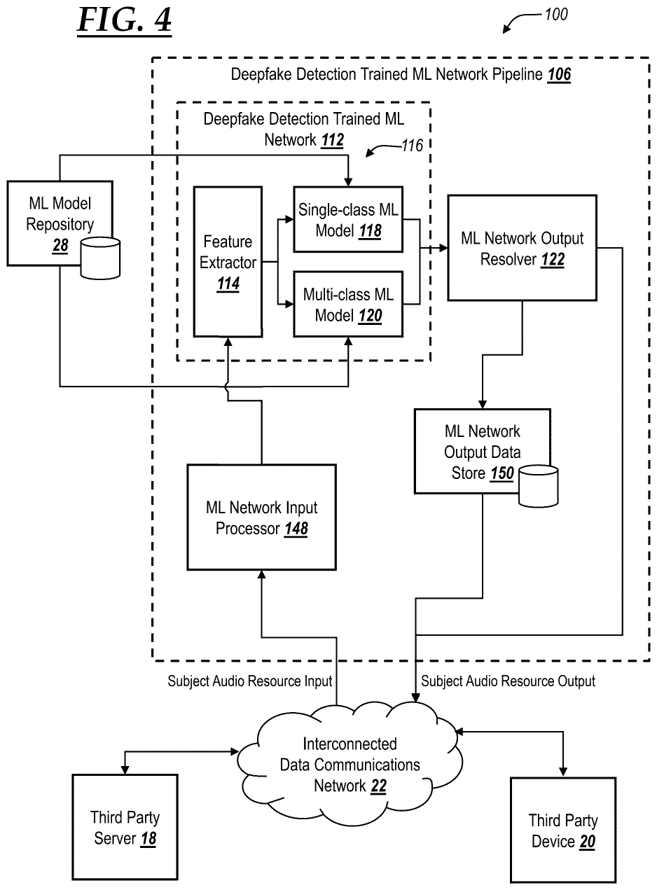

With specific reference now to FIG. 4, the deepfake detection trained ML network pipeline 106 is shown as including an ML network input processor 148 for receiving a subject audio resource input and preparing the subject audio resource indicated thereby for input into the trained ML network 112, the feature extractor 114 for generating audio feature data for the subject audio resource, the deepfake detection classifier network 116 (including its single-class ML model 118 and multi-class ML model 120), the ML network output resolver 122 for determining a deepfake detection indicator, and a ML network output data store 150 for storing the deepfake detection indicator. The deepfake detection indicator may be provided as the subject audio resource output to a third party, and this output may be provided directly from the ML network output resolver 122 or from the ML network output data store 150.

The feature extractor 114 is shown as being separate from each of the single-class ML model 118 and the multi-class ML model 120. More particularly, the feature extractor 114 obtains a subject audio resource as input and in a form as prepared by the ML network input processor 148, and then uses the subject audio resource to generate audio feature data that is then input into each of the single-class ML model 118 and the multi-class ML model 120. The feature extractor 114 is used for extracting audio features from the subject audio resource and, in embodiments, the extracted audio features may be latent features or may be features corresponding to known speech or audio attributes, such as prosody, articulation, and phonation, for example. According to one embodiment, the feature extractor 114 is used to extract one or more prosody features, one or more articulation features, and one or more phonation features from the subject audio resource, and these extracted audio features are represented as audio feature data.

Prosody audio features are based on fundamental frequency (referred to “fundamental frequency based features”), energy (referred to “energy-based features”), and duration (referred to “duration-based features”). Fundamental frequency (F0) based features include the following features: F0-contour Avg., Std., Max., Min., Skewness, Kurtosis (Prosody Features 1-6); tilt of a linear estimation of F0 for each voiced segment Avg., Std., Max., Min., Skewness, Kurtosis (Prosody Features 7-12); mean-squared-error (MSE) of a linear estimation of F0 for each voiced segment Avg., Std., Max., Min., Skewness, Kurtosis (Prosody Features 13-18); F0 on the first voiced segment Avg., Std., Max., Min., Skewness, Kurtosis (Prosody Features 19-24); and F0 on the last voiced segment Avg., Std., Max., Min., Skewness, Kurtosis (Prosody Features 25-30). These first thirty (30) audio features are each an example of a fundamental frequency based prosody audio feature.

In regards to prosody audio features, energy-based features may include one or more of the following features: energy-contour for voiced segments Avg., Std., Skewness, Kurtosis (Prosody Features 31-34); tilt of a linear estimation of energy contour for V segments Avg., Std., Skewness, Kurtosis (Prosody Features 35-38); MSE of a linear estimation of energy contour for V segment Avg., Std., Skewness, Kurtosis (Prosody Features 39-42); energy on the first voiced segment Avg., Std., Max., Min., Skewness, Kurtosis (Prosody Features 43-48); energy on the last voiced segment Avg., Std., Max., Min., Skewness, Kurtosis (Prosody Features 49-54); energy-contour for unvoiced segments Avg., Std., Skewness, Kurtosis (Prosody Features 55-58); tilt of linear estimation of energy contour for U segments Avg., Std., Skewness Kurtosis (Prosody Features 59-62); MSE of a linear estimation of energy contour for U segments Avg., Std., Skewness, Kurtosis (Prosody Features 63-66); energy on the first unvoiced segment Avg., Std., Max., Min., Skewness, Kurtosis (Prosody Features 67-72); and energy on the last unvoiced segment Avg., Std., Max., Min., Skewness, Kurtosis (Prosody Features 73-78). These forty eight (48) audio features are each an example of an energy-based based prosody audio feature.

In regards to prosody audio features, duration-based features may include one or more of the following features: voiced rate Number of voiced segments per second (Prosody Feature 79); duration of voiced Avg., Std., Max., Min., Skewness, Kurtosis (Prosody Features 80-85); duration of unvoiced Avg., Std., Max., Min., Skewness, Kurtosis (Prosody Features 86-91); duration of pauses Avg., Std., Max., Min., Skewness, Kurtosis (Prosody Features 92-97); and duration ratios pause/(voiced+unvoiced), pause/unvoiced, unvoiced/(voiced+unvoiced), voiced/(voiced+unvoiced), voiced/pause, unvoiced/pause (Prosody Features 98-103). These twenty five (25) audio features are each an example of a duration-based prosody audio feature.

Articulation audio features refer to those features pertaining to the shaping of sounds into words, such as through forming consonant and vowel sounds. Articulation audio features may include: Bark band energies in onset transitions (Articulation Features 1-22); Mel frequency cepstral coefficients (MFCCs) in onset transitions (Articulation Features 23-34); first derivative of the MFCCs in onset transitions (Articulation Features 35-46); Second derivative of the MFCCs in onset transitions (Articulation Features 47-58); Bark band energies in offset transitions (Articulation Features 59-80); MFCCs in offset transitions (Articulation Features 81-92); first derivative of the MFCCs in offset transitions (Articulation Features 93-104); second derivative of the MFCCs in offset transitions (Articulation Features 105-116); the first formant frequency (Articulation Features 117); first Derivative of the first formant frequency (Articulation Feature 118); second derivative of the first formant frequency (119); second formant Frequency (Articulation Feature 120); first derivative of the second formant frequency (Articulation Feature 121); and second derivative of the second formant frequency (Articulation Feature 122). In embodiments, each of these exemplary articulation audio features may be used and formed as a static feature vector with four-hundred eighty-eight (Articulation Feature 488) features, including one-hundred twenty-two (122) descriptors x four (4) functions: mean (“Avg.”), standard deviation (“Std.”), skewness, and kurtosis.

Phonation audio features refer to those features that are based on sustained vowels and continuous speech utterances. According to one embodiment, seven (7) descriptors are computed over the voice segments, including: first derivative of the fundamental frequency; second derivative of the fundamental frequency; jitter; shimmer; amplitude perturbation quotient; pitch perturbation quotient; and logarithmic energy. In one embodiment, a static feature vector is formed with 28 phonation audio features and contains seven (7) descriptors x four (4) functionals (Avg., Std., skewness, kurtosis).

The above-discussed audio features for the subject audio resource are then used as input into the deepfake detection classifier network 116, which is used to generate a deepfake detection indicator for the subject audio resource, which may then be communicated to a user or other computer system, or stored in memory for later use.

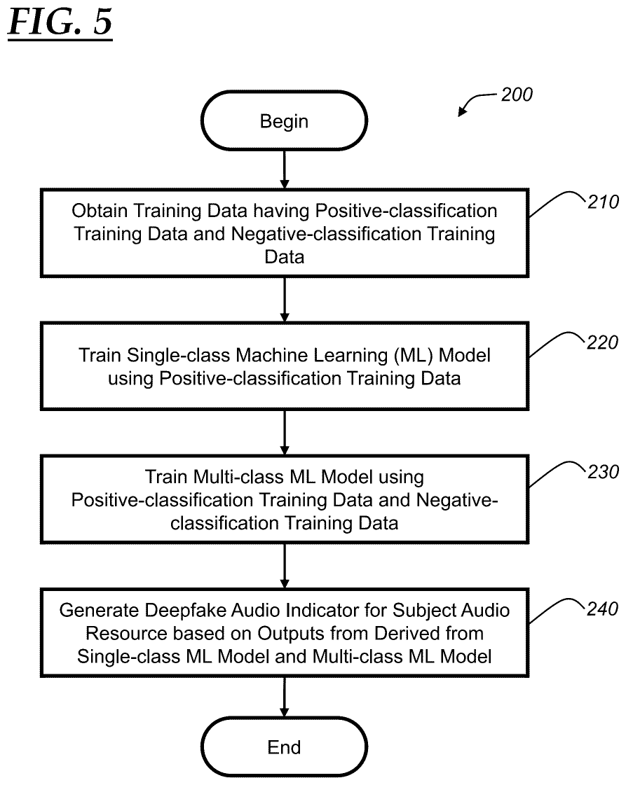

With reference to FIG. 5, there is shown a method 200 of detecting a deepfake audio resource. The method 200 is performed by the deepfake audio detection system 12, at least in embodiments. Although the steps 210-240 are illustrated and described as being performed in a particular order, those skilled in the art will appreciate that the steps may be performed according to any technically-feasible order, such as where step 230 is performed concurrently with or prior to step 220, for example.

The method 200 is described as being performed for detecting deepfakes for a particular speaker and, accordingly, is used for performing speaker-specific deepfake audio detection, which refers to detecting whether a subject audio resource having audio of speech of the speaker is legitimate or not, such as where the subject audio resource is a deepfake, using a deepfake detection model that is specifically tailored to the speaker. Moreover, in the present embodiment, the speaker-specific deepfake detection is performed by the deepfake detection ML network pipeline 102 whereby a deepfake detection ML network is specifically trained for a particular individual (referred to as a “speaker”), and then used for determining whether unseen audio resources are legitimate or not. The speaker for which the method 200 below is performed is referred to as the “subject speaker.” After the speaker-specific ML model is trained (using steps 210-230), the trained speaker-specific ML model is used for determining whether an audio resource is fake or illegitimate or not, and this audio resource is referred to as the “subject audio resource.”

The method 200 begins with step 210, wherein training data is obtained, including positive-classification training data and negative-classification training data. As used herein, “positive-classification training data,” when used in connection with training a ML model for classification, refers to training data having inputs corresponding to outputs (ML model outputs) indicating a first predetermined (or positive) class rather than a second predetermined (or negative) class. Moreover, in the present embodiment, there may be multiple negative classes determinable through use of a multi-class ML model. Also, as used herein, “negative-classification training data,” when used in connection with training a ML model for classification, refers to training data having inputs corresponding to outputs (ML model outputs) indicating one or more second predetermined (or negative) class(es) rather than the first predetermined (or positive) class. In the present context, “positive” refers to a class (ML classification model output) representing bonafide or legitimate (non-deepfake) audio resources, and one negative class for the single-class ML model and multiple negative classes for the multi-class ML model.

In one embodiment, the training data is obtained from a third party, such as from the third party server 18 and/or the third party device 20. In some embodiments, the training data is generated, at least in part, by the deepfake detection ML network training pipeline 104. For example, in embodiments, the speaker-specific deepfake generation pipeline 126 is used for generating deepfake versions of bonafide audio resources and, in the present embodiment, these deepfake versions are used as a part of the negative-classification training data. The training data is obtained using the speaker data collection pipeline 124, at least in one embodiment. The method 200 continues to step 220.

In step 220, a single-class ML model is trained using the positive-classification training data. According to one embodiment, the single-class ML model is trained using only the positive-classification training data, which means that the negative-classification training data (which is used for training the multi-class ML model) is not used for training the single-class ML model. However, in other embodiments, the single-class ML model may be trained using negative-classification training data in addition to or in lieu of the positive-classification data. The single-class ML model is a one-class support vector machine (SVM) that is trained using the positive-classification data only and configured to generate a binary indication of whether a given input is an inlier (or normal) and assigned a positive class (e.g., corresponding to a value of one (1)) or is an outlier (or an anomaly) and assigned a negative class (e.g., corresponding to a value of zero (0) or negative one (−1)). In one embodiment, the positive-classification training data, which consists only of inputs corresponding to the positive class, meaning those inputs are inliers. A training: test split of 70:30 may be used for the training data, as discussed above. In some embodiments, a training data set of at least one thousand (1000) audio samples of each having audio of no more than twenty seconds is used for training the one-class SVM. In another embodiment, a smaller number of audio samples with more aggressive learning may be performed, although this may be more prone to false negatives as it will have an inlier bound not encompassing unseen legitimate audio samples, potentially, depending on the nature and number of the positive-classification training data. The ML network trainer 24 is used for obtaining a base SVM model, obtaining the positive-classification training data (step 210), and then training the base SVM model using a decision boundary learning process for learning an inlier or normal boundary for the given training data used for training, which would be real or legitimate speech features extracted via the feature extractor 114 from real audio samplings or resources. The method 200 continues to step 230.

In step 230, a multi-class ML model is trained using the positive-classification training data and the negative-classification training data. The multi-class ML model is a Gaussian mixture model (GMM) trained for identifying a subject audio resource as being illegitimate or legitimate and, in at least some embodiment, a type of deepfake or otherwise classed into one of a plurality of negative classes. The ML network trainer 24 is used for obtaining a base GMM, obtaining the training data (step 210), and then training the multi-class ML model using an expectation-maximization (EM) algorithm. In embodiments, two classes may be used for the GMM, but where each class includes multiple components, enabling sub-class classifications; however, in other embodiments, the GMM is configured with three or more classes, each with one or more components. A training:test split of 70:30 may be used for the training data, as discussed above. The method 200 continues to step 240.

In step 240, a deepfake audio indicator is generated for a subject audio resource. In embodiments, the deepfake audio indicator is based on a single-class output and a multi-class output. In one embodiment, the subject audio resource is received at the deepfake ML network pipeline 102 and, specifically, the deepfake detection trained ML network pipeline 106 whereby the subject audio resource may be pre-processed using the ML network input processor 148 and then input into the deepfake detection trained ML network 112. In particular, a subject audio resource ML input is generated from the subject audio resource at the ML network input processor 148 so that audio from the subject audio resource input into the deepfake detection trained ML network 112 is formatted, normalized, standardized, tokenized, encoded, string or byte padded, and/or otherwise packaged, prepared, and/or processed in order to be in a suitable form for use by the deepfake detection ML network 112 used for determining the deepfake audio indicator.

The subject audio resource is used as input into the feature extractor 114, such as by inputting the subject audio resource ML input into the feature extractor 114. The extracted audio features are then input into both the single-class ML model 118 and the multi-class ML model 120. Using the extracted audio features, the single-class ML model 118 generates a single-class ML model output, which is a binary indicator indicating whether the subject audio resource is legitimate or not. Also, using the extracted audio features, the multi-class ML model 120 generates a multi-class ML model output, which is an indicator indicating whether the subject audio resource is legitimate or not, and may indicate sub-classifications thereof, such as a probable or predicted type of deepfake or laundering attack is used on the subject audio resource. The single-class ML model output and the multi-class ML model output are then used as input into the ML network output resolver 122, which then makes a final determination as to whether the subject audio resource is a deepfake or otherwise illegitimate or not, which is then represented as the deepfake audio indicator.

In some embodiments, the subject audio resource is input into a trained ML network having parameters learned as a result of the training of the single-class ML model and the multi-class ML model. The trained ML network corresponds to the deepfake detection trained ML network 112, at least in one embodiment. However, in other embodiments, another ML network is trained based on the trained single-class ML model and the trained multi-class ML model, and this may be referred to as a unified ML mode. In such embodiments, for example, the unified ML model is trained using reinforcement learning (RL) in a dynamic process where training data is generated automatically using the trained single-class ML model 118 and the trained multi-class ML model 120. This data generation begins by inputting a set of subject audio resources into the trained ML network 112, such as into the feature extractor 114, which then generates features used as input into both the single-class ML model 118 and the multi-class ML model 120. The outputs of these models are then used to determine a final output (the deepfake audio indicator), which may be performed by applying predetermined logic, lookup tables, or other reasoning through use of the ML network output resolver 122, for example. In other embodiments, a ML network having a plurality of ML models (as opposed to a single or unitary model) is trained in a similar fashion to that of the unitary model. These further-trained ML networks may be used for determining deepfake audio indicators for subject audio resources. The method 200 ends.

In embodiments, after the deepfake audio indicator is generated in step 240, the deepfake audio indicator is stored in a data store (e.g., the ML network output data store 150) for later use and/or may be sent or otherwise provided to the third party server 18, the third party device 20, or other device, server, or system via the interconnected data communications network 22, for example.

In embodiments, the step 240 of the method 200 is performed once for each of a plurality of subject audio resources so as to generate a plurality of deepfake audio indicators, which may then be stored in a data store (e.g., the ML network output data store 150) and/or may be sent or otherwise provided to the third party server 18, the third party device 20, or other device, server, or system via the interconnected data communications network 22, for example.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of detecting a deepfake audio resource, comprising the steps of:
obtaining training data having positive-classification training data and negative-classification training data;
training a single-class machine learning (ML) model using the positive-classification training data;
training a multi-class machine learning (ML) model using the positive-classification training data and the negative-classification training data; and
generating a deepfake audio indicator for a subject audio resource based on a single-class output and a multi-class output, wherein the single-class output is generated through inputting the subject audio resource into the single-class ML model, and wherein the multi-class output is generated through inputting the subject audio resource into the multi-class ML model.

2. The method of claim 1, wherein the single-class ML model is or includes a support vector machine (SVM) trained on the positive-classification training data.

3. The method of claim 1, wherein the multi-class ML model is or includes a Gaussian mixture model (GMM) trained on the positive-classification training data and the negative-classification training data.

4. The method of claim 1, wherein the single-class ML model is or includes a support vector machine (SVM) trained on the positive-classification training data, and wherein the multi-class ML model is or includes a Gaussian mixture model (GMM) trained on the positive-classification training data and the negative-classification training data.

5. The method of claim 1, wherein the training data is generated using a training data generation process, and wherein the training data generation process includes a spoof audio generation process for generating deepfake audio resources used as the negative-classification training data.

6. The method of claim 1, wherein either or both of the single-class ML model and the multi-class ML model is/are trained for a public figure or other particular individual.

7. The method of claim 1, wherein the single-class ML model is trained for an individual and the multi-class ML model is trained for the individual.

8. The method of claim 1, wherein a trained single-class ML model is generated as a result of training the single-class ML model, wherein a trained multi-class ML model is generated as a result of training the multi-class ML model, wherein a unitary ML model is trained using reinforcement learning (RL) in which RL training data is automatically generated through inputting a plurality of subject audio resources into the trained single-class ML model and the trained multi-class ML model to generate a plurality of deepfake audio indicators for the plurality of subject audio resources, and wherein the RL training data includes a plurality of RL training data entries each having one of the subject audio resources and a corresponding one of the plurality of deepfake audio indicators.

9. A method of detecting a deepfake audio resource, comprising the steps of:
obtaining a plurality of trained expert machine learning (ML) models, wherein the plurality of trained expert ML models includes two or more experts configured for a common or different detection tasks;
obtaining a trained gating model configured to generate per-expert weights and/or routing decisions based on one or more inputs associated with a subject audio resource;
inputting the subject audio resource into each of the plurality of trained expert ML models to generate a plurality of expert outputs, wherein each expert output of the plurality of expert outputs is an output of a different one of the plurality of trained expert ML models;
inputting at least one of: (i) a feature representation derived from the subject audio resource and/or (ii) one or more of the plurality of expert outputs into the trained gating model to generate gating outputs indicating relative weighting or selection of the plurality of trained expert ML models; and
generating a deepfake audio indicator for the subject audio resource by fusing the plurality of expert outputs in accordance with the gating outputs.

10. The method of claim 9, wherein the gating outputs control contribution of each of the plurality of trained expert ML models to the deepfake audio indicator.

11. The method of claim 9, wherein the plurality of trained expert ML models includes any one or more of the following: one or more speaker-specific experts, one or more channel or capture-condition experts, one or more attack-type experts, and one or more laundering experts.

12. The method of claim 9, wherein the trained gating model is configured to generate soft routing weights comprising continuous-valued per-expert weights, and wherein fusing the plurality of expert outputs comprises computing a weighted aggregation of the plurality of expert outputs using the soft routing weights.

13. The method of claim 9, wherein the trained gating model is configured to perform hard routing by selecting a subset of the plurality of trained expert ML models based on a routing criterion, and wherein fusing the plurality of expert outputs comprises combining outputs only from the selected subset.

14. The method of claim 9, wherein the trained gating model receives as input one or more of: (i) an embedding derived from the subject audio resource, (ii) side information associated with the subject audio resource, and/or (iii) one or more uncertainty measures derived from the plurality of expert outputs.

15. The method of claim 14, wherein the side information associated with the subject audio resource includes one or more environmental or transmission characteristics derived from the subject audio resource.

16. The method of claim 9, wherein fusing the plurality of expert outputs comprises score-level fusion and/or temporal fusion, wherein score-level fusion includes at least one of weighted averaging, logistic regression stacking, Bayesian model averaging, temperature scaling, or isotonic calibration, and wherein temporal fusion is performed by aggregating expert outputs over multiple time segments of the subject audio resource prior to generating the deepfake audio indicator.

17. The method of claim 9, further comprising providing the fused output to an output resolver configured to generate the deepfake audio indicator based on one or more decision thresholds.

18. The method of claim 17, wherein the output resolver is further configured to generate one or more auxiliary outputs including at least one of: (i) a predicted attack type, (ii) a confidence score, (iii) an uncertainty estimate, (iv) an identified channel or capture condition, and/or (v) an identified speaker grouping.

19. The method of claim 17, wherein the output resolver applies a risk-aware decision policy comprising at least one of: (i) selecting a minimum or maximum spoof score among the plurality of expert outputs, (ii) applying a conservative threshold conditioned on an uncertainty measure, and (iii) generating a flag for further review when disagreement among the plurality of expert outputs exceeds a predefined threshold.

20. The method of claim 9, wherein fusing the plurality of expert outputs comprises computing a weighted sum of the plurality of expert outputs using per-expert weights generated by the trained gating model.

21. The method of claim 9, wherein fusing the plurality of expert outputs comprises stacking, including inputting the plurality of expert outputs into a meta-classifier configured to generate the deepfake audio indicator.

22. The method of claim 9, wherein the trained gating model comprises a neural network configured to implement a mixture-of-experts framework that generates continuous-valued weights applied to the plurality of expert outputs.

23. The method of claim 9, wherein the trained gating model receives, as part of the one or more inputs associated with the subject audio resource, an estimated codec type associated with the subject audio resource.

24. The method of claim 9, wherein the trained gating model receives, as part of the one or more inputs associated with the subject audio resource, an estimated signal-to-noise ratio (SNR) associated with the subject audio resource.

25. The method of claim 9, wherein the trained gating model receives one or more conditioning signals including at least one of: a codec estimate, a signal-to-noise ratio estimate, a reverberation estimate, a capture-type estimate, metadata associated with a source platform, and/or a speaker identity estimate.

26. The method of claim 9, further comprising adapting the system to a new deployment domain by updating parameters of the trained gating model while maintaining parameters of the plurality of trained expert ML models fixed.

27. The method of claim 26, wherein adapting the system further comprises updating parameters of a fusion layer or calibration layer without retraining the plurality of trained expert ML models.

28. A system for detecting deepfake audio, comprising:
one or more processors; and
a non-transitory, computer-readable memory storing computer instructions;
wherein execution of the computer instructions by the one or more processors causes the system to:
obtain a plurality of trained expert machine learning (ML) models, the plurality of trained expert ML models including two or more experts configured for a common detection task or for different detection tasks;
obtain a trained gating model configured to generate per-expert weights or routing decisions based on one or more inputs associated with a subject audio resource;
input the subject audio resource into each of the plurality of trained expert ML models to generate a corresponding plurality of expert outputs;
input at least one of (i) a feature representation derived from the subject audio resource and/or (ii) one or more of the plurality of expert outputs into the trained gating model to generate gating outputs indicating relative weighting or selection of the plurality of trained expert ML models; and
generate a deepfake audio indicator for the subject audio resource by fusing the plurality of expert outputs in accordance with the gating outputs, wherein the gating outputs control contribution of each of the plurality of trained expert ML models to the deepfake audio indicator.

29. The system of claim 28, wherein the execution of the computer instructions causes the system to provide the fused output to an output resolver configured to generate the deepfake audio indicator based on one or more decision thresholds.

30. The system of claim 28, wherein the execution of the computer instructions further causes the system to adapt to a new microphone, platform, language, or channel condition by retraining the trained gating model while keeping the plurality of trained expert ML models frozen.

31. A method of detecting a deepfake audio resource, comprising the steps of:
obtaining a subject audio resource;
computing one or more feature representations or embeddings from the subject audio resource;
executing a plurality of machine learning (ML) models using at least one of the one or more feature representations or embeddings to generate a corresponding plurality of model outputs;
computing a combination of the plurality of model outputs by determining one or more weights, selection decisions, or aggregation parameters; and
generating, based on the combination of the plurality of model outputs, an indicator representing whether the subject audio resource is manipulated.

32. The method of claim 31, wherein computing the combination of the plurality of model outputs comprises at least one of: weighted averaging, logistic regression stacking, Bayesian model averaging, or learned gating.

33. The method of claim 31, wherein computing the combination of the plurality of model outputs comprises updating only aggregation parameters associated with the combination while maintaining parameters of the plurality of machine learning models unchanged.

34. A non-transitory, computer-readable medium, wherein the non-transitory, computer-readable medium stores computer instructions that, when executed by one or more processors, cause the method of claim 31 to be performed.
